(19) United States
(12) Patent Application Publication
(10) Pub. No.: US 2024/0396411 A1
(43) Pub. Date: Nov. 28, 2024

(54) COUPLING METHOD FOR ENDS OF ELECTRICAL CABLES OF AN INDUCTIVE WINDING AND THE LIKE

(71) Applicant: ATOP S.P.A., Barberino (IT)

(72) Inventors: Rubino CORBINELLI, Poggibonsi, Frazione Staggia Senese (IT); Daniele NOCCIOLINI, Firenze (IT); Barbara PREVITALI, Milano (IT); Ali Goekhan DEMIR, Milano (IT); Simone D'ARCANGELO, Pescara (IT); Leonardo CAPRIO, Milano (IT); Davide CHESI, Certaldo (IT)

(21) Appl. No.: 18/704,493

(22) PCT Filed: Oct. 10, 2022
(86) PCT No.: PCT/EP2022/078057

§ 371 Date: Apr. 25, 2024

(30) Foreign Application Priority Data
Oct. 26, 2021 (IT) 2021000027431

(51) Int. Cl. H02K 15/00; B23K 26/36; H01B 13/00

(52) U.S. Cl. CPC H02K 15/00; B23K 26/36; H01B 13/0036

(57) ABSTRACT

A coupling method for ends of electrical cables of an inductive winding. The cables are constituted by an electrically conducting core covered by a layer of dielectric material. The method comprises a first step of juxtaposing side faces of distinct ends that are arranged substantially parallel, and a second step of welding the ends that have the faces juxtaposed. The method consists of providing, before the first step, at least one engraved groove on the surface of at least one side face. The at least one groove will determine an asymmetry in the respective wettability on the face, consisting of a greater wettability in the longitudinal direction than in the transverse direction.

The present invention relates to a coupling method for ends of electrical cables of an inductive winding and the like.

Electric motors, dynamos, alternators and transformers comprise a core of ferromagnetic material on which windings are arranged which are made with electrical cables arranged according to a specific geometry. The circulation of a current in at least one of the windings determines, by electromagnetic induction, the circulation of an induced current in at least one other winding. Furthermore, forces between the windings and the respective ferromagnetic cores act on each other and are capable, for example, of turning the rotor with respect to the stator in an electric motor.

Inductive windings are made with elements made of electrically conducting material (generally copper) which are covered with a layer of dielectric material (not electrically conducting), for their insulation. For specific applications, providing the windings is done using pieces of electrically conducting material coupled to each other at at least one end, which are inserted into the specific recesses present in the ferromagnetic cores of the machine under construction. These pieces are known as “hairpins” in the jargon and they require, before their insertion into the respective recesses, preparatory operations to remove the layer of surface insulation dielectric material from their end surfaces (which can subsequently be coupled, generally using welding methods).

The layer of dielectric material can be removed by mechanical abrasion (a technique that is falling out of use in industry), by stock-removal machining, or by laser ablation (using CO₂ lasers or fiber lasers). It should be noted that CO₂ lasers are adapted to remove dielectric material, but they cannot be used to remove material from the elements made of electrically conducting material (generally copper).

CO₂ lasers are of low cost, but the quality of the ablation of the layer of dielectric material is not excellent because, after the treatment, residues of this material remain which could compromise the quality (and also the appearance) of the welding of the ends of the treated hairpins.

Fiber lasers, which cost more, carry out a removal of material that also includes the surface layers of the electrical conductor, and therefore they ensure the complete elimination of the dielectric layer. The ends of the hairpins, thus treated, will ensure welds that do not show aesthetic defects, even if they do not always ensure that a strong and stable coupling of those ends is obtained.

The aim of the present invention is to solve the above mentioned drawbacks, by providing a coupling method for ends of electrical cables of an inductive winding and the like that ensures a strong join thereof.

Within this aim, an object of the invention is to provide a coupling method for ends of electrical cables of an inductive winding and the like that ensures a stable join thereof.

Another object of the invention is to provide a coupling method for ends of electrical cables of an inductive winding and the like that ensures a join that is substantially free from aesthetic defects.

Another object of the invention is to provide a coupling method for ends of electrical cables of an inductive winding and the like in which all residues of the dielectric layer for insulating the ends to be joined by welding are first eliminated.

Another object of the invention is to provide a coupling method for ends of electrical cables of an inductive winding and the like that is completely automatic.

Another object of the present invention is to provide a coupling method for ends of electrical cables of an inductive winding and the like which is of low cost, easily and practically implemented and safe in use.

This aim and these objects are achieved by a coupling method for ends of electrical cables of an inductive winding according to claim 1.

Further characteristics and advantages of the invention will become better apparent from the detailed description that follows of a preferred, but not exclusive, embodiment of the coupling method for ends of electrical cables of an inductive winding and the like, which is illustrated by way of non-limiting example in the accompanying drawings wherein:

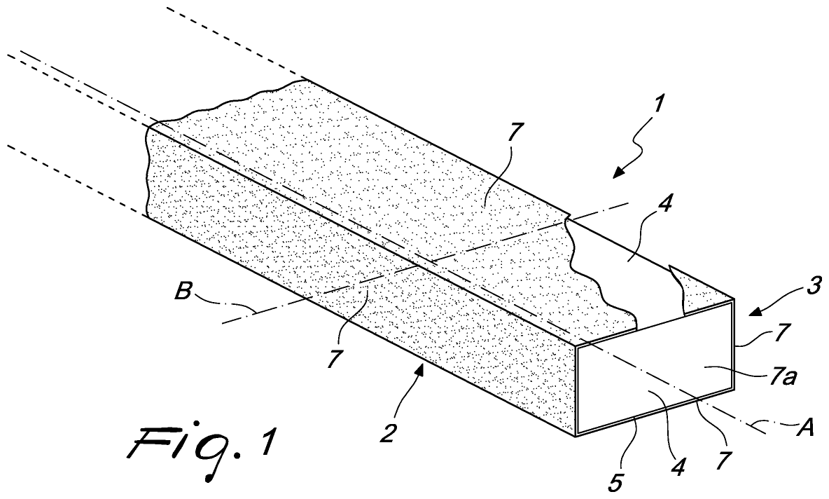

FIG. 1 is a partially cross-sectional schematic perspective view of an end of an electrical cable of an inductive winding and the like;

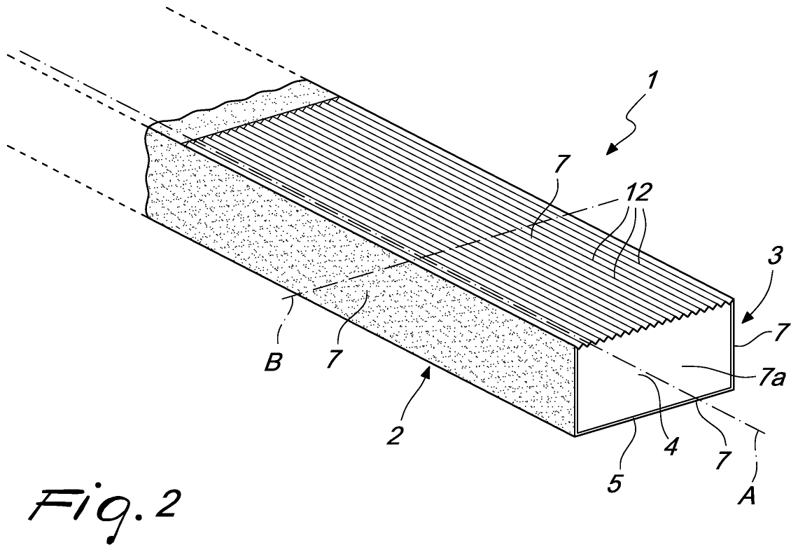

FIG. 2 is a schematic perspective view of an end of an electrical cable with longitudinal surface grooves;

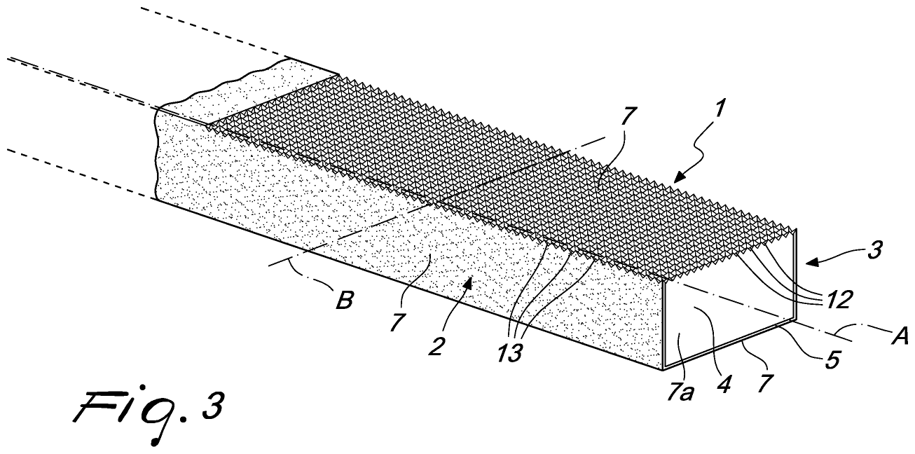

FIG. 3 is a schematic perspective view of an end of an electrical cable with both longitudinal and transverse surface grooves;

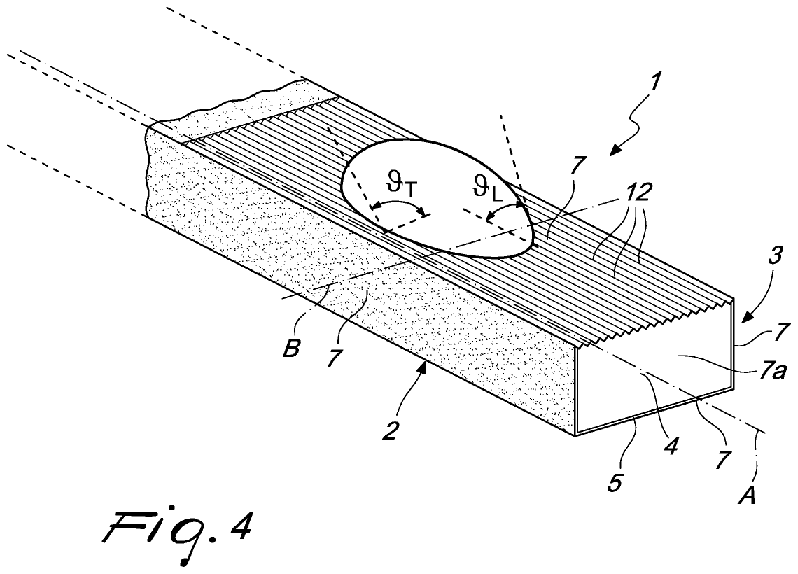

FIG. 4 is a schematic perspective view of the grooved end of FIG. 2 in which the contact angles corresponding to the wettability of the corresponding longitudinally grooved face are indicated;

FIG. 5 is a schematic perspective view of the grooved end of FIG. 3 in which the contact angles corresponding to the wettability of the corresponding bidirectionally grooved face are indicated;

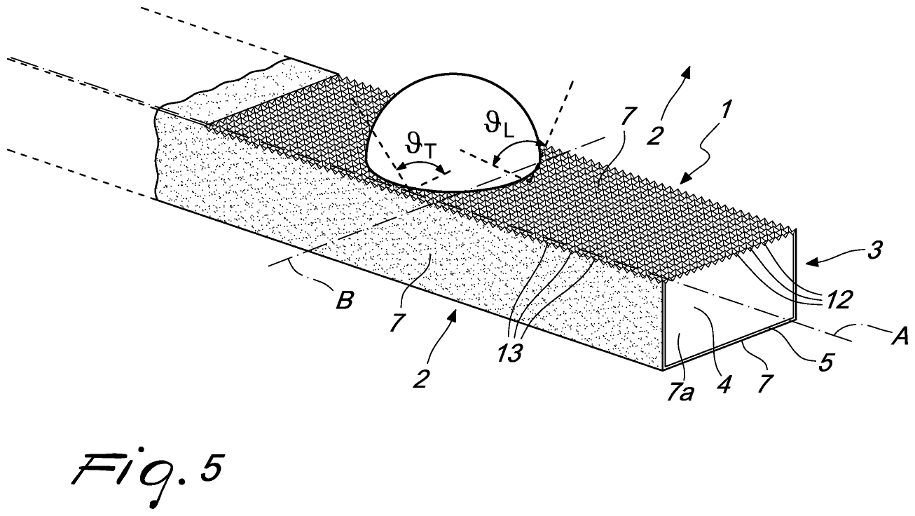

FIG. 6 is a schematic perspective view of two grooved ends as in FIG. 2 being brought together;

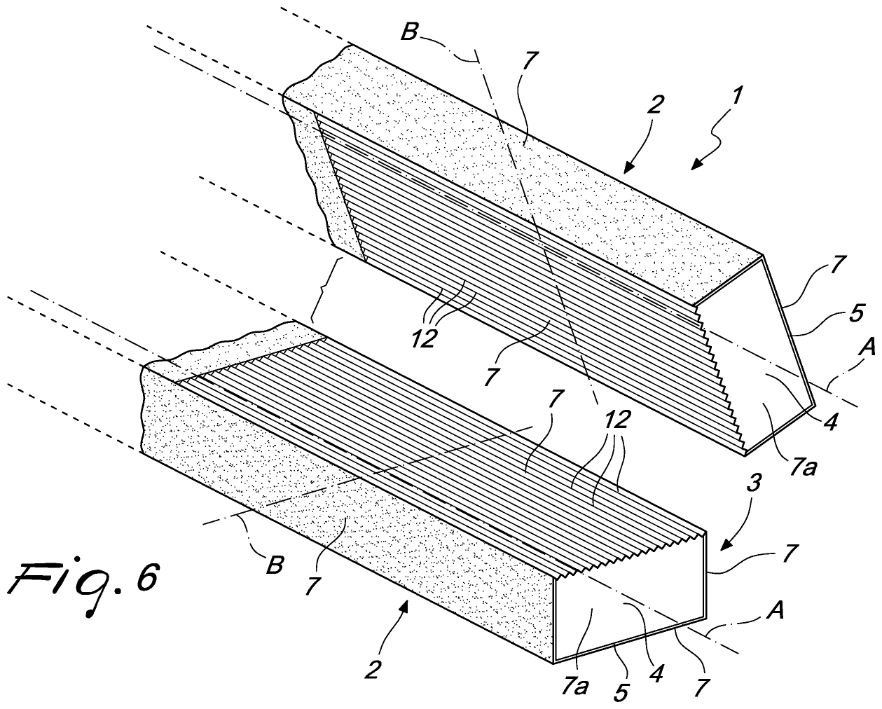

FIG. 7 is a schematic perspective view of two ends, grooved on a single side face, as in FIG. 2, juxtaposed;

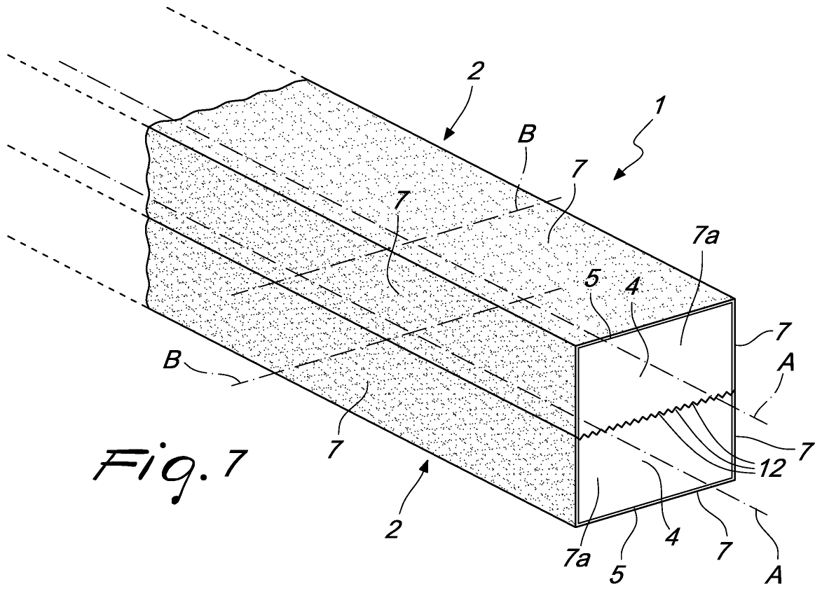

FIG. 8 is a block diagram representing the coupling method according to the invention;

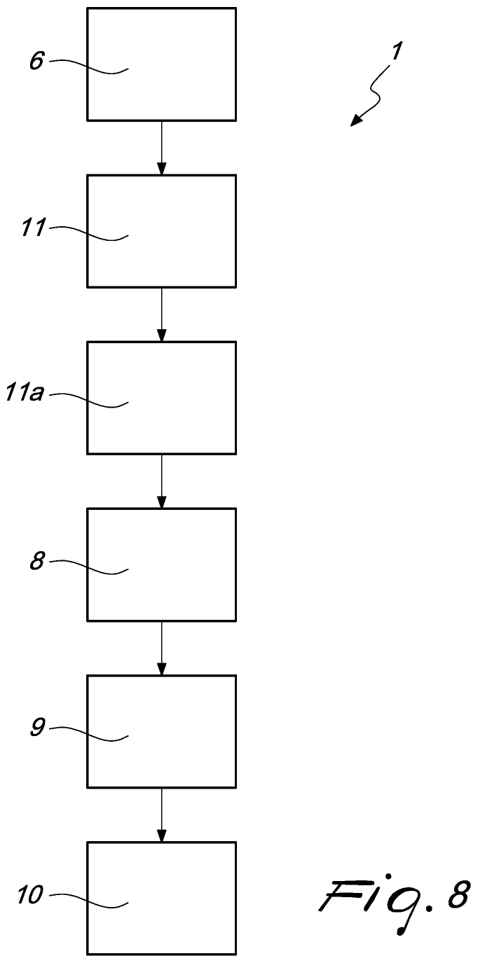

FIG. 9 is a schematic perspective view of two ends, grooved on all side faces, juxtaposed;

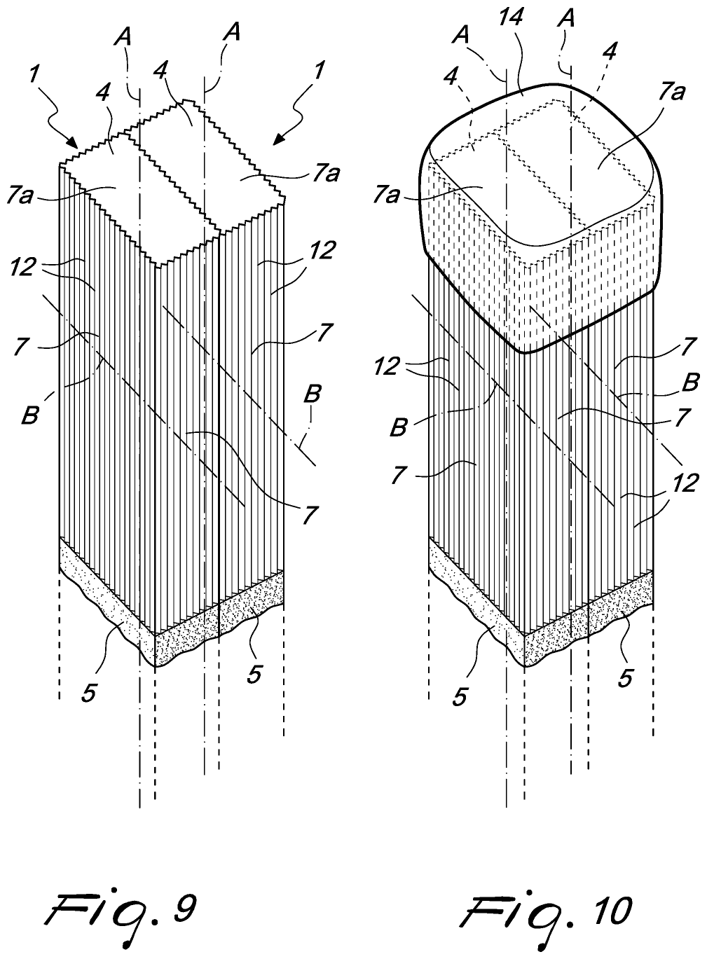

FIG. 10 is a schematic perspective view of two ends, grooved on all side faces, juxtaposed, at the end of the welding thereof;

FIG. 11 is a schematic side view of an end of an electrical cable with a first possible variation of embodiment of longitudinal surface grooves;

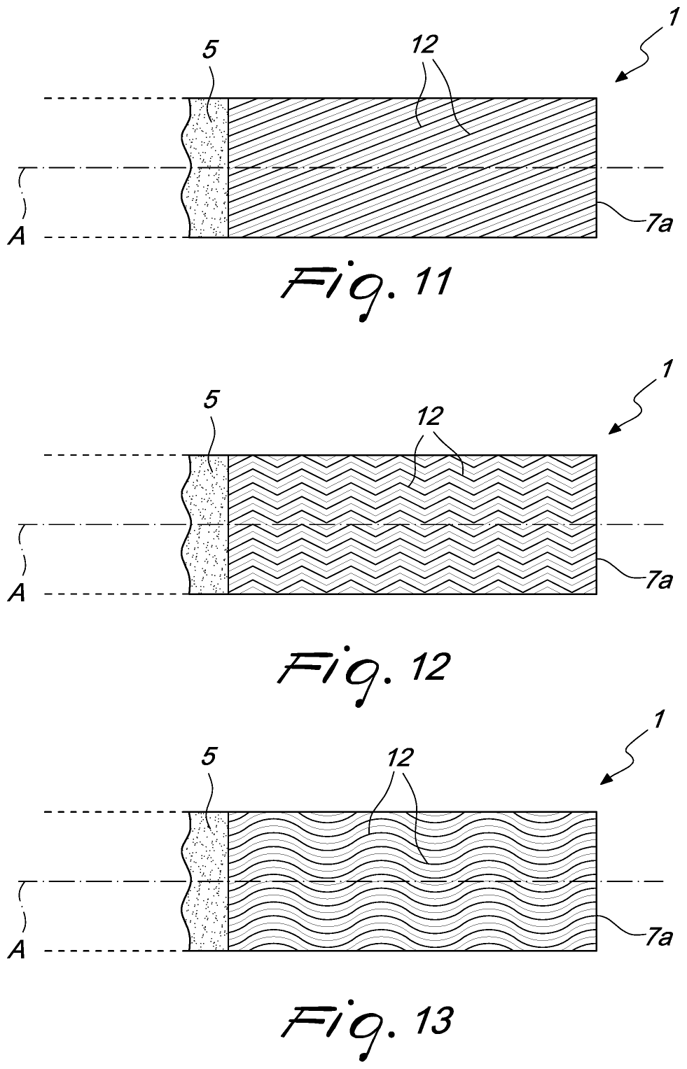

FIG. 12 is a schematic side view of an end of an electrical cable with a second possible variation of embodiment of longitudinal surface grooves;

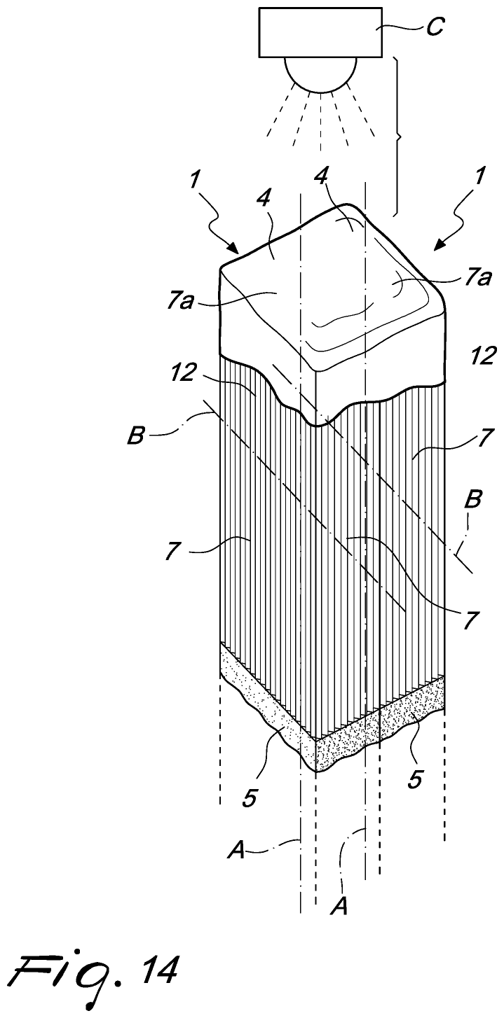

FIG. 13 is a schematic side view of an end of an electrical cable with a third possible variation of embodiment of longitudinal surface grooves;

FIG. 14 is a schematic perspective view of two ends, grooved on all side faces, juxtaposed, in a first step of the welding thereof in which the molten metal begins to pour;

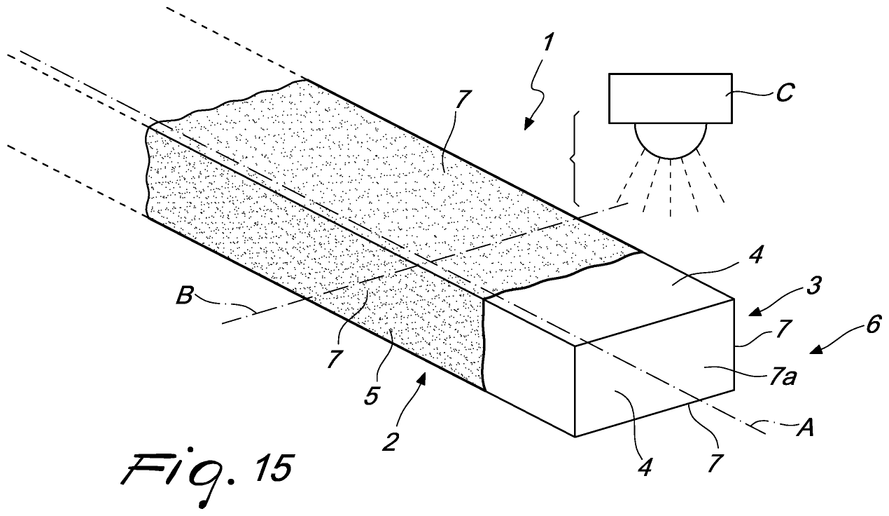

FIG. 15 is a schematic perspective view of the step of stripping an electrical cable according to the invention.

With reference to the figures, the reference numeral 1 generally designates a coupling method for ends 2 of electrical cables 3 of an inductive winding and the like.

It should be noted that in the present description the term electrical cables 3 should be understood to mean any component made of electrically conducting material (a core 4) covered by a layer of dielectric material (dielectric layer 5) for its insulation. This definition therefore includes multi-wire (or braided) cables, in which the electrically conducting component (constituting the core 4) is constituted by a series of filaments brought together and/or braided, and single-wire cables, in which the electrically conducting component (constituting the core 4) is constituted by a single element of any cross-section (circular, polygonal, irregular).

An inductive winding is constituted by a wound circuit made using a filament of conducting material, generally copper wire, covered by a thin insulating film; generally, in order to increase the inductance value, the winding is carried out on a core of ferromagnetic material. Among the inductive windings of principal interest in the background art are those of electrical machines: one example is the circuit of the stator of an electric motor (in which the ferromagnetic body is tubular in shape and the wires of the winding are inserted into axial recesses that run parallel to the lines of the inner cylindrical cavity); in such case the wires are wound along specific paths that determine and favor the generation of the torque (of magnetic origin) with which the stator induces the rotation of the rotor.

The ends 2 of the electrical cables 3 of an inductive winding will each comprise at least one side face 7 which is substantially parallel to a respective longitudinal axis A and a respective base face 7a which is transverse with respect to the longitudinal axis A and to the respective side face 7.

For each cable a transverse direction will also be identified, referable to an axis B.

The coupling method 1 according to the invention comprises:
a first step 8 of juxtaposing at least two of such side faces 7 which belong to distinct ends 2 arranged substantially parallel;
a second step of welding 9 the ends 2 that have these juxtaposed faces 7. It should be noted that the welding step 9 can be executed using any conventional technique (such as for example laser welding, plasma welding, electric arc welding and other conventional techniques), although the description below will detail those of most practical interest (which however are not exclusive).

During the second welding step 9, the juxtaposed side faces 7 of the two ends 2 to be welded together will be oriented vertically, so that their end base 7a (oriented transversely with respect to those side faces 7) is directed upward: in this manner, the melting of a part of the end 2 proximate to the base 7a will determine a pouring of molten metal along the side faces 7, by virtue of which the welding together of the two ends 2 will occur.

At the end of this second step 9 the finished element can be obtained (extraction of the finished element 10), and can be installed in accordance with the specifications of the design (for example in the stator of an electric motor or in another winding of the inductive type).

According to the invention, it is necessary to carry out a step 11 of surface texturing, before the second step 8 of juxtaposing the side faces 7 of the ends 2, in which at least one engraved groove 12 is generated on the surface of the core 4 of at least one of the side faces 7. Such at least one groove 12 can determine, on the at least one face 7, an asymmetry in the wettability, in particular a greater wettability in the longitudinal direction (along the axis A) than in the transverse direction (along the axis B).

The longitudinal direction (along the axis A) is considered to be the direction of extension of the cable 3 (which coincides with the direction of the axis of the end 2), and the transverse direction (along the axis B) is the direction perpendicular to the longitudinal direction just defined.

In order to specify with greater clarity the characteristics of the surface grooves 12 that it will be convenient to provide using the method 1 according to the invention, it is necessary to explain scientific concepts used to define the surface interactions that exist at a solid/liquid interface, in physics.

Liquid/solid interaction is of great relevance in defining the properties of the surfaces of the materials. One widely-used measurement for this purpose is the contact angle θ, which is reached by measuring the wettability of a surface.

Wettability is the physical property whereby a body, and in particular a solid surface, in air can be wetted by a liquid.

Wettability is characterized by the contact angle θ formed by the liquid/solid, gas/solid, and gas/liquid interface tensions.

The contact angle θ is correlated with the surface tension and with the thermodynamic equilibrium between two phases, and is determined by measuring the “wetting” of a surface: by depositing a droplet of liquid (it is recalled that a molten metal is in the liquid state) on a surface it is possible to calculate the contact angle θ formed by the gas/liquid interface with respect to the solid. Conventionally, surfaces that have a contact angle with water of less than 90° are considered hydrophilic, while surfaces with an angle greater than 90° are hydrophobic (i.e. water-repellent). Using the results of analyses of surface tension and contact angle θ it is possible to obtain information essential to optimizing all processes and applications based on phase interactions, and assess variations of wettability experienced by machined or functionalized surfaces.

The method optionally entails a stripping step 6 (this is a preliminary step) which entails the at least partial removal of the layer of dielectric material 5 from side faces 7 of at least one end 2 of each cable 3. The stripping step 6, although optional, ensures a considerable increase in the quality of the subsequent second step 9 of welding the ends 2 with these faces 7 juxtaposed, in that it makes it possible to eliminate the dielectric material which could generate contaminants or irregularities in the molten material, thus compromising the quality and the mechanical hold of the weld. The stripping step 6 is preferably implemented in the method according to the invention, while not being strictly necessary.

It should be noted that the stripping step 6 of at least partial removal of the layer of dielectric material 5 from the side faces 7 entails the removal, from the external surface of at least one side face 7 of at least one end 2, of contiguous portions of that end 2 which extend along a direction at least partially parallel to the longitudinal axis of the cable 3.

More precisely, the grooves 12 will conveniently have a direction with a longitudinal component greater than the transverse component, taking the direction of extension of the cable 3 as the longitudinal direction.

In practice, such portions will be substantially constituted by multi-material strips removed from a respective face 7 of the end 2.

Each one of such portions comprises an elongated fragment of the layer of dielectric material 5 and a substantially prismatic element of the core 4.

The removal of such multi-material strips from at least one face 7 of the end 2 of a cable 3 defines the at least one engraved surface groove 12 on such at least one face 7 (because the removed mutually parallel contiguous strips leave a track on the respective face 7 of the type of an engraved groove 12, which exposes the core 4 of electrically conducting material to the outside environment).

According to the invention, it should be noted that the longitudinal surface grooves 12 can advantageously have a first contact angle θ_{L} in the longitudinal direction that is smaller than a second contact angle θ_{T} in the transverse direction.

Such configuration ensures that the distribution of a liquid that is deposited on the side face 7 that bears the grooves 12 will extend over a greater length in the longitudinal direction, with respect to how far it extends in the transverse direction (again with respect to the direction of extension of the cable 3).

This makes it possible to increase the flow of the molten metal (which will be in the liquid state) during the coupling by melting (in step 9) of the two ends 2 with the grooves 12 on their corresponding side faces 7.

The increase in the dimensions of the surfaces covered by the molten material will ensure a greater strength of the welding and a higher tearing strength of the coupling of the two ends 2.

The first contact angle θ_{L} will preferably be less than 90°, although solutions are not ruled out in which such first contact angle θ_{L} has values of around 90° (therefore also slightly higher than that value).

The first contact angle θ_{L} in the longitudinal direction must be understood as the contact angle formed by the interface between the liquid (the molten metal) and the air, with respect to the solid (the body of the end 2).

Since the ends are kept with a generally vertical arrangement during the welding step 9, the greater wettability in the longitudinal direction makes it possible to take best advantage of the effect of gravity on the molten material which will descend along the faces 7, thus ensuring a greater contact surface along which the melting (and corresponding coupling) will occur.

More specifically, if only the engraved surface grooves 12 are present on the face 7, the first contact angle θ_{L} in the longitudinal direction will conveniently need to be less than 90°, thus defining engraved surface grooves 12 that will ensure a higher quality, solidity and stability of the welding that will be carried out of the ends 2 in the subsequent step 9 after having juxtaposed the faces 7 by substantially placing the respective grooves 12 against each other.

According to a possible variation of embodiment, it should be noted that on each face 7 a step 11a can profitably also be executed in which at least one second, transverse groove 13 is provided which has a direction substantially perpendicular to the longitudinal direction of the respective end 3.

Such at least one second, transverse groove 13, therefore, will intersect the at least one longitudinal groove 12 at the region of the face 7 where removal of the material has been carried out.

In an implementation solution that could be used to optimize the welding (which can be of the type carried out with a laser source, with plasma welding or with electric arc welding), to be executed in the subsequent step 9 of the method 1 between the ends 2 by superimposing the faces 7 that comprise the engraved grooves 12 and 13, the second contact angle θ_{T} in the transverse direction is advantageously proximate to 90° and the first contact angle in the longitudinal direction θ_{L} does not exceed (is less than or equal to) 90°, so as to maintain the condition according to which the wettability in the longitudinal direction is better than the wettability in the transverse direction.

It should be noted that the welding will occur via the melting of a part of the cable (the part proximate to the base 7a) and that the molten metal (in the liquid state) will be aided in flowing along the lateral surface 7 that bears the grooves 12, 13, precisely as a result of the better wettability of such surfaces which is induced by the presence of the grooves 12, 13 (the molten metal can flow easily along the walls 7 by using the grooves 12, 13 as eased conveyance channels). The longitudinal grooves 12 create channels that favor the flow of the molten metal.

From a practical point of view, it should be noted that in the method 1 according to the invention the optional stripping step 6 of at least partial removal of the layer of dielectric material 5 from at least one of the side faces 7 of at least one end 2 of each cable 3 can conveniently be carried out using a laser C of type chosen from a CO₂ laser, a fiber laser and the like.

Obviously the possibility is not ruled out of carrying out a mechanical abrasion of the indicated material from at least one face 7, although the use of the laser C makes it possible to speed up such operations and ensure a high quality of the result obtained.

It should furthermore be noted that the stripping step 6 of removal of the layer of dielectric material 5 can be executed by means of an at least partial ablation of such layer 5 using a CO₂ laser C, and can be constituted by the removal, executed with a fiber laser C, from the external surface of at least one side face 7 of parts of the end which comprise any residue of dielectric material 5 and a portion of the electrically conducting core 4, generating engraved lines 12 and/or 13 on the surface of the core 4 of such at least one side face 7.

The removal of material up to the generation of the engraved grooves 12 and/or 13 on at least one face 7 being worked ensures that any residue of dielectric material (of the original layer 5) has been eliminated: such condition defines a better quality of the welding that will need to be carried out in the subsequent step 9 of the method 1, because residues of dielectric material during the welding may be a source of contaminants and/or a source of irregularities of any kind and/or may generate black halos in the melted material, which then on solidifying might not ensure the ideal coupling of the ends 2.

It should furthermore be noted that, with particular reference to an embodiment of clear practical and applicative interest, the stripping step 6 of removal, at least partial, of the layer of dielectric material 5 from at least one side face 7 can conveniently be executed only with a fiber laser C.

In such case such stripping step 6 (which—it is again emphasized—is optional) will advantageously comprise the removal of the layer 5 of dielectric material and the removal of a portion of the conducting core 4, thus generating engraved lines 12 and/or 13 on the surface of the core 4 of such at least one side face 7.

Independently of how the surface texture will be created on the at least one face 7 (which can therefore be constituted by the grooves 12 or by the combination of the grooves 12 and 13), the juxtaposition of these faces 7 (of two distinct ends 2), with mutual abutment of the respective texture, will facilitate the process of mutual adhesion that occurs following the welding in step 9.

In particular, the presence of the engraved grooves 12 and/or 13 facilitates the flow along them of a predefined amount of molten metal (during the welding step 9) which will be interposed between the facing and mutually opposite grooves 12 and/or 13 (and, if the grooves 12 and/or 13 are present on all the side faces 7, they will be interposed also along those external side faces 7 thus facilitating their incorporation into the melted material that will flow along those same faces 7): the subsequent solidification of the molten metal penetrated inside the grooves 12 and/or 13 (by gravity, by capillary action or by other physical phenomena in specific applications) will ensure a perfect adhesion between the faces 7 that were mutually juxtaposed in step 8.

The melted material 14 can flow freely along the grooved side faces 7, by virtue of their greater wettability in the longitudinal direction, and therefore the “droplet” of melted material will cover the two ends 2 more completely than would happen in the absence of the grooves 12.

The coupling by welding in step 9 can therefore be carried out on ends 2 each having a single face 7 that bears grooves 12 (and/or 13) (in such case the melted material 14 will flow along the grooves 12 on a greater surface than there would be in the absence of the grooves 12 and will ensure a higher mechanical strength and a higher quality of the welding), or on ends 2 each having two or more (even all four) faces 7 with grooves 12 (and/or 13) (in such case the melted material 14 will flow along all the grooves 12 on a greater surface than there would be in the absence of the grooves 12, embedding the pair of ends 2 externally as well, and will ensure a higher mechanical strength and a higher quality of the welding). The term “higher quality of the welding” also means a higher tearing strength.

By virtue of the method 1 according to the invention a considerable increase is therefore obtained of the quality of the welds between ends 2 of cables 3 used to make inductive windings (for example used to make the stators of electric motors).

It should be noted that the step of providing the surface grooves 12 and/or 13 and the step 9 of mutually welding the two ends 2 are generally actuated, in practice, not immediately consecutively.

In fact, the cables 3 with the ends 2 already bearing surface grooves 12 and/or 13 can be subjected to operations of bending and/or arrangement inside the recesses of an electrical machine (by way of non-limiting example, inside the recesses of the stator of an electric motor) and/or twisting (in conformance with the characteristics of the type of inductive winding to be provided) before being welded together (in pairs) according to the specific logic required by the inductive winding to be provided.

Advantageously the present invention solves the above mentioned problems, by providing a coupling method 1 for ends 2 of electrical cables 3 of an inductive winding and the like that ensures a strong join thereof.

Conveniently the method 1 according to the invention ensures a stable join of the ends 2.

Profitably the method 1 according to the invention ensures a join that is substantially free from aesthetic defects.

Advantageously the method 1 according to the invention makes it possible to first eliminate all residues of the dielectric insulation layer 5 of the ends 2 to be joined by welding.

Positively the method 1 according to the invention can be completely automatic and/or is capable of being automated.

Positively the coupling method 1 according to the invention is easily and practically implemented and is of low cost: such characteristics make the method 1 according to the invention an innovation that is safe in use.

The invention, thus conceived, is susceptible of numerous modifications and variations, all of which are within the scope of the appended claims. Moreover, all the details may be substituted by other, technically equivalent elements.

In particular it should be noted that the grooves 12 can be constituted by linear scorings (which can be parallel to the longitudinal axis of the end 2 or by scorings that are variously inclined with respect to that axis, while still forming an angle of less than 90° with such axis, as illustrated for the purposes of non-limiting example in FIG. 11) or by scorings that are variously shaped and mutually adjacent (as illustrated for the purposes of non-limiting example in FIG. 12, in which the scorings are arranged with the pattern of a jagged line, and in FIG. 13, in which the scorings are shown with a sinuous pattern). Further variations of embodiment are not ruled out for the grooves 12 and, if present, the accessory grooves 13, while remaining within the scope of the inventive concept described and, subsequently, claimed.

In the embodiments illustrated, individual characteristics shown in relation to specific examples may in reality be interchanged with other, different characteristics, existing in other embodiments.

In practice, the materials employed, as well as the dimensions, may be any according to requirements and to the state of the art.

The disclosures in Italian Patent Application No. 102021000027431 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-16. (canceled)

17. A coupling method for ends of electrical cables of an inductive winding, each one of which comprises at least one side face which is substantially parallel to a respective longitudinal axis and a respective base face which is transverse with respect to the longitudinal axis and to the respective side face, said cables being constituted by an electrically conducting core covered by a layer of dielectric material, said method comprising a first step of juxtaposing side faces of distinct ends that are arranged substantially parallel, a second step of welding said distinct ends arranged with said side faces juxtaposed, said welding being carried out by melting at least one portion of a base surface so as to generate molten metal, said method comprising the execution, before said first step of juxtaposing said side faces of said ends, of a texturing step which consists of providing at least one engraved groove on a surface of at least one of said juxtaposed side faces, so as to create at least one channel that is configured to make the molten metal generated on the base surface flow and so as to determine, on the surface that contains said at least one engraved groove, a greater wettability in the longitudinal direction than in the transverse direction.

18. The coupling method according to claim 17, wherein a longitudinal component of a direction of said at least one engraved groove is greater than a transverse component, with reference to a longitudinal direction of the cable.

19. The coupling method according to claim 17, further comprising a stripping step to remove at least partially said layer of dielectric material from said juxtaposed side faces.

20. The coupling method according to claim 17, wherein said texturing step is carried out while said first step of stripping is carried out and it entails a removal, from an external surface of at least one of said juxtaposed side faces, of contiguous portions of said end which extend along a direction parallel to the respective longitudinal axis of the respective cable, each one of said contiguous portions comprising an elongated fragment of said layer of dielectric material and a substantially prismatic element of said core.

21. The coupling method according to claim 17, wherein the side face bearing said at least one engraved groove has a wettability whereby a first contact angle, defined as an angle formed by a liquid/gas interface meeting a liquid/solid interface, in the longitudinal direction with a molten metal is smaller than a second contact angle in the transverse direction.

22. The coupling method according to claim 21, wherein said first contact angle in the longitudinal direction is less than 90°.

23. The coupling method according to claim 17, wherein said texturing step comprises the provision, on the surface of at least one of said juxtaposed side faces, of at least one first, longitudinal groove and at least one second, transverse groove the direction of which is substantially perpendicular to the longitudinal direction of the respective end, said at least one second, transverse groove intersecting said at least one longitudinal groove.

24. The coupling method according to claim 17, wherein said stripping step to remove at least partially said layer of dielectric material from at least one of said side faces of at least one end of each cable is executed using an apparatus chosen from between abrasive tools for stock-removal machining, and a laser of type chosen from a CO2 laser and a fiber laser.

25. The coupling method according to claim 20, wherein said stripping step to remove at least partially said layer of dielectric material from at least one of said side faces of at least one end of each cable is executed initially using a CO2 laser, so as to obtain an at least partial ablation of said layer of dielectric material, and, subsequently, using a fiber laser, so as to remove any residue of dielectric material from the external surface of at least one side face of said at least one end.

26. The coupling method according to claim 25, wherein said texturing step is executed with said fiber laser while the stripping step is being completed, thus generating engraved grooves on the surface of said core of at least one of said juxtaposed side faces.

27. The coupling method according to claim 20, wherein both said texturing step and said stripping step of said layer of dielectric material from at least one of said side faces is executed using a fiber laser, and comprises a removal of said layer of dielectric material and a simultaneous removal of a portion of said conducting core, thus generating said at least one engraved groove on the surface of at least one of said juxtaposed side faces of said core.

28. The coupling method according to claim 17, wherein said at least one engraved groove is present on all the side faces of said end.

29. The coupling method according to claim 17, wherein said at least one engraved groove is provided using a fiber laser.

30. The coupling method according to claim 17, wherein said at least one side wall is oriented vertically and said transverse base surface is directed upward at least during the second step of welding.

31. The coupling method according to claim 17, wherein said second step of welding said ends is carried out by a laser source.

32. The coupling method according to claim 17, wherein said at least one channel, created on the at least one of the juxtaposed side faces, extends along a longitudinal direction substantially parallel to the longitudinal axis.
